(19) United States
(12) Patent Application Publication
(10) Pub. No.: US 2026/0046079 A1
(43) Pub. Date: Feb. 12, 2026

(54) SECURE DEMODULATION REFERENCE SIGNAL (DMRS) FOR ENHANCED PRIVACY IN WIRELESS COMMUNICATIONS

(71) Applicant: QUALCOMM Incorporated, San Diego, CA (US)

(72) Inventors: Soo Bum LEE, San Diego, CA (US); Wei YANG, San Diego, CA (US); Gavin Bernard HORN, La Jolla, CA (US)

(21) Appl. No.: 18/747,061

(22) Filed: Jun. 18, 2024

(51) Int. Cl. H04L 5/00; H04W 48/16

(52) U.S. Cl. CPC H04L 5/0048; H04L 5/0058; H04W 48/16

(57) ABSTRACT

An apparatus, method and computer-readable media are disclosed for performing wireless communications. For example, a process can include deriving a physical layer key based on an access stratum key shared with the network node; generating a first demodulation reference signal (DMRS) pattern based on the physical layer key and at least one of one or more DMRS pattern parameters or one or more DMRS pattern restrictions; generating a DMRS signal based on the first DMRS pattern; and transmitting an uplink data transmission based on the generated DMRS signal to the network node, the uplink data transmission including one or more DMRS resource elements (REs) located based on the first DMRS pattern.

### FIELD

The present disclosure generally relates to wireless communications. For example, aspects of the present disclosure relate to a secure demodulation reference signal (DMRS) for enhanced privacy in wireless communications.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, a wireless device for communicating with a network node is provided. The wireless device includes a memory system comprising instructions and a processor system coupled to the memory system. The processor system is configured to: derive a physical layer key based on an access stratum key shared with the network node; generate a first demodulation reference signal (DMRS) pattern based on the physical layer key and at least one of one or more DMRS pattern parameters or one or more DMRS pattern restrictions; generate a DMRS signal based on the first DMRS pattern; and transmit an uplink data transmission based on the generated DMRS signal to the network node, the uplink data transmission including one or more DMRS resource elements (REs) located based on the first DMRS pattern.

In another example, a method for communicating with a network node by a wireless device is provided. The method includes: deriving a physical layer key based on an access stratum key shared with the network node; generating a first demodulation reference signal (DMRS) pattern based on the physical layer key and at least one of one or more DMRS pattern parameters or one or more DMRS pattern restrictions; generating a DMRS signal based on the first DMRS pattern; and transmitting an uplink data transmission based on the generated DMRS signal to the network node, the uplink data transmission including one or more DMRS resource elements (REs) located based on the first DMRS pattern.

As another example, a non-transitory computer-readable medium is provided. The non-transitory computer-readable medium has stored thereon instructions that, when executed by a processor system, cause the processor system to: derive a physical layer key based on an access stratum key shared with the network node; generate a first demodulation reference signal (DMRS) pattern based on the physical layer key and at least one of one or more DMRS pattern parameters or one or more DMRS pattern restrictions; generate a DMRS signal based on the first DMRS pattern; and transmit an uplink data transmission based on the generated DMRS signal to the network node, the uplink data transmission including one or more DMRS resource elements (REs) located based on the first DMRS pattern.

In another example, an apparatus is provided. The apparatus comprises: means for deriving a physical layer key based on an access stratum key shared with the network node; means for generating a first demodulation reference signal (DMRS) pattern based on the physical layer key and at least one of one or more DMRS pattern parameters or one or more DMRS pattern restrictions; means for generating a DMRS signal based on the first DMRS pattern; and means for transmitting an uplink data transmission based on the generated DMRS signal to the network node, the uplink data transmission including one or more DMRS resource elements (REs) located based on the first DMRS pattern.

As another example, a network node for communicating with a wireless device is provided. The network node includes: a memory system comprising instructions; and a processor system coupled to the memory system. The processor system is configured to: derive a physical layer key based on an access stratum key; generate a first demodulation reference signal (DMRS) pattern based on the physical layer key and any of: one or more DMRS pattern parameters; and one or more DMRS pattern restrictions; receive an uplink data transmission from the wireless device, wherein the uplink data transmission includes one or more DMRS resource elements (REs) located based on the first DMRS pattern; and decode the uplink data transmission based on the one or more DMRS REs.

In another example, a method for communicating with a wireless device by a network node is provided. The method includes: deriving a physical layer key based on an access stratum key; generating a first demodulation reference signal (DMRS) pattern based on the physical layer key and any of: one or more DMRS pattern parameters; and one or more DMRS pattern restrictions; receiving an uplink data transmission from the wireless device, wherein the uplink data transmission includes one or more DMRS resource elements (REs) located based on the first DMRS pattern; and decoding the uplink data transmission based on the one or more DMRS REs.

As another example, a non-transitory computer-readable medium is provided. The non-transitory computer-readable medium has stored thereon instructions that, when executed by a processor system, cause the processor system to: derive a physical layer key based on an access stratum key; generate a first demodulation reference signal (DMRS) pattern based on the physical layer key and any of: one or more DMRS pattern parameters; and one or more DMRS pattern restrictions; receive an uplink data transmission from the wireless device, wherein the uplink data transmission includes one or more DMRS resource elements (REs) located based on the first DMRS pattern; and decode the uplink data transmission based on the one or more DMRS REs.

In another example, an apparatus is provided. The apparatus comprises: means for deriving a physical layer key based on an access stratum key; means for generating a first demodulation reference signal (DMRS) pattern based on the physical layer key and any of: one or more DMRS pattern parameters; and one or more DMRS pattern restrictions; means for receiving an uplink data transmission from the wireless device, wherein the uplink data transmission includes one or more DMRS resource elements (REs) located based on the first DMRS pattern; and means for decoding the uplink data transmission based on the one or more DMRS REs.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a resource grid illustrating an example of an uplink frame structure, according to aspects of the disclosure;

FIG. 6 is a resource grid illustrating a secure DMRS pattern, in accordance with aspects of the present disclosure;

FIG. 7 is a flow diagram illustrating a process for accessing a wireless network by a wireless device, in accordance with aspects of the present disclosure;

FIG. 8 is a flow diagram illustrating a process for providing access to a wireless system by a wireless node, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. As noted above, 5G mobile standard calls for higher data transfer speeds, greater numbers of connections, and better coverage, among other improvements. 5G is expected to support several hundreds of thousands of simultaneous connections. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network.

Wireless networks and other communications technologies often include an architecture that is arranged in layers where different protocols of a layer responsible for specific tasks and/or functionalities. In some cases, security for connections with a wireless network may be implemented at a certain protocol layer. For example, in certain 3GPP systems, security for wireless connections may be implements in a Packet Data Convergence Protocol (PDCP) layer. Layers below the PDCP layer, such as the physical (PHY) layer, medium access control (MAC) layer, radio link control (RLC) layer, etc. may not be secured and transmissions for those layers may be in the clear. While privacy sensitive information is not likely to be revealed by these lower layers with PDCP security in place, it is possible that lower layer protection may help enhance confidential/private wireless communication in the future. For example, MAC control elements (MAC CE) may carry control information about a UE, unauthenticated emergency calls may not be security protected at all. In some cases, securing lower layer communication protocols may help avoid potential side channel information leakage from lower layer information.

Reference signals are predefined signals occupying specific resource elements within a time-frequency grid of a resource block and may be exchanged on one or both of downlink and uplink physical communication channels. Each reference signal has been defined by the 3rd Generation Partnership Project (3GPP) for a specific purpose, such as for channel estimation, phase-noise compensation, acquiring downlink/uplink channel state information, time and frequency tracking, among others.

Example reference signals include, but are not limited to, Positioning Reference Signal (PRS), Sounding Reference Signal (SRS), Channel State Information—Reference Signal (CSI-RS), De-Modulation Reference Signal (DMRS), among others. Some reference signals (e.g., PRS, CSI-RS, etc.) are downlink specific signals, while others such as DMRS are sent both on downlink and uplink communication channels. There are also uplink specific reference signals defined by the 3GPP.

In some cases, the DMRS may be used to estimate a channel to allow a wireless device (e.g., UE) to communicate with a wireless node (e.g., eNB, gNB, DU, etc.). Estimating a channel allows a receiver to decode received signals. In some cases, if a received cannot properly estimate a channel, the receive may not be able to, or have a difficult time, decoding the received signals. In some cases, using a DMRS pattern and/or DMRS sequence that is known only to a transmitter and specific intended receiver can prevent (or make it very difficult for) eavesdroppers from decoding any intercepted wireless signals between the transmitter and intended receiver, thus potentially increasing privacy. The DMRS pattern may define one or more locations of the DMRS signal in a transmitted signal, and the DMRS sequence may define the information in the DMRS signal.

Systems, apparatuses, processes (also referred to as methods), and computer-readable media (collectively referred to as “systems and techniques”) are described herein for randomizing DMRS patterns and/or DMRS sequences for securing DMRS for enhanced privacy in wireless communications. For example, a wireless node of a wireless network may configure a wireless device, such as a UE, to use randomized DMRS patterns and/or DMRS sequences. After an access stratum (AS) security has been established with the wireless device, the wireless node may provide the wireless device with one or more parameters that may be used for a physical layer key. The physical layer key may be a string of random/pseudorandom characters that may be used for cryptographic operations associated with the physical layer of a wireless communication network (e.g., wireless network). The wireless device may derive a physical layer key based on the AS key and the one or more parameters received from the wireless node. Using the physical layer key, the wireless node and/or the wireless device may generate a DMRS pattern. In some cases, a different DMRS pattern may be generated for each transmission. In some cases, different DMRS patterns may be generated based on a freshness parameter. The freshness parameter may be a string of characters that may vary to allow a new result (e.g., DMRS pattern) to be generated without refreshing a key. The DMRS pattern may be subject to one or more DMRS pattern restrictions. The wireless node may then send a downlink data transmission to the wireless node. The downlink data transmission may include DMRS resource elements distributed based on a DMRS pattern. For example, a wireless signal may be divided into multiple resource elements (REs) which correspond with a certain time/frequency of the wireless signal. The DMRS REs of the wireless signal may carry the DMRS signal and how the DMRS REs are distributed within the wireless signal may be defined by the DMRS pattern. Similarly, the wireless device may then send an uplink data transmission to the wireless node. The uplink data transmission may include DMRS resource elements distributed based on a DMRS pattern. The uplink DMRS pattern may differ from the downlink DMRS pattern.

In some cases, DMRS pattern restrictions may help avoid generating DMRS patterns which may degrade channel estimation accuracy. These DMRS pattern restrictions may include a set number of symbols for carrying the DMRS, a minimum symbol spacing (e.g., number of symbols) between DMRS REs, a minimum number of DMRS REs in a symbol, a minimum spacing between DMRS tones, a maximum spacing between DMRS tones, a maximum distance between REs and a DMRS RE, any combination thereof, and/or other restrictions. The specific DMRS pattern restrictions that a wireless device may use may be indicated (e.g., configured) by the wireless node. In some cases, to apply the DMRS pattern restrictions, more potential DMRS locations may be generated for the DMRS pattern than may be used for the downlink or uplink transmission, and potential DMRS location may be skipped based on the DMRS pattern restrictions.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

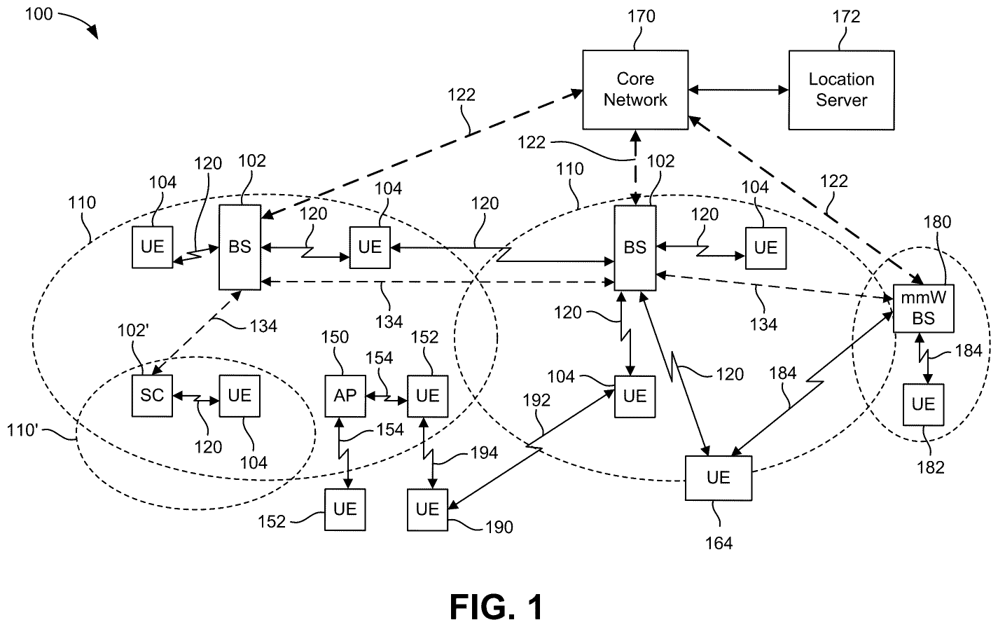

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes. ” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells. ” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’ The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

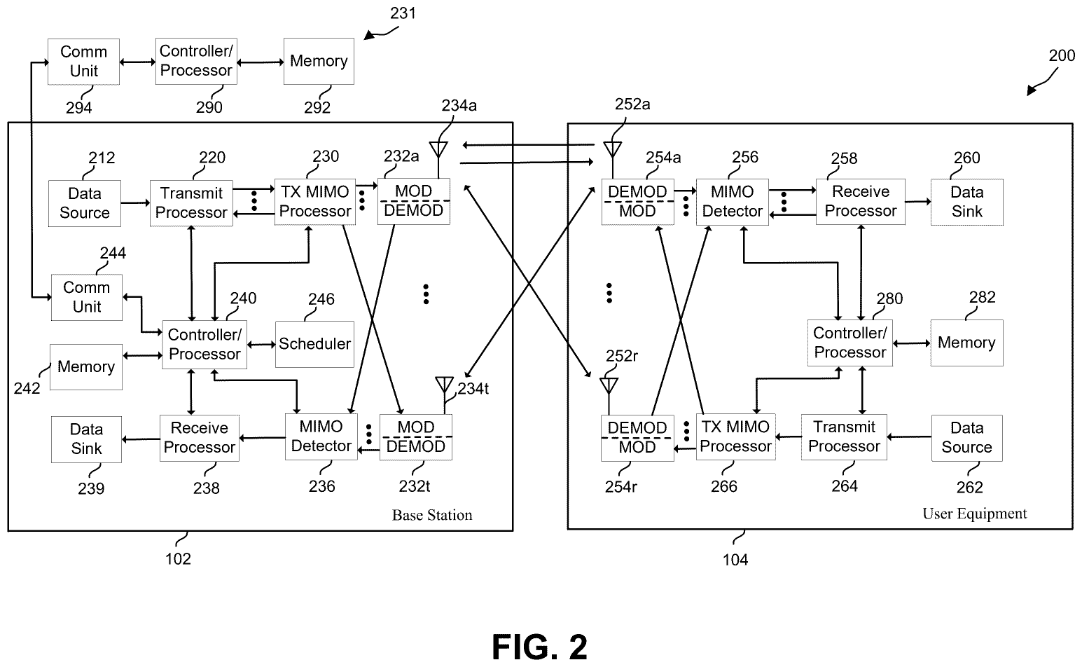

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

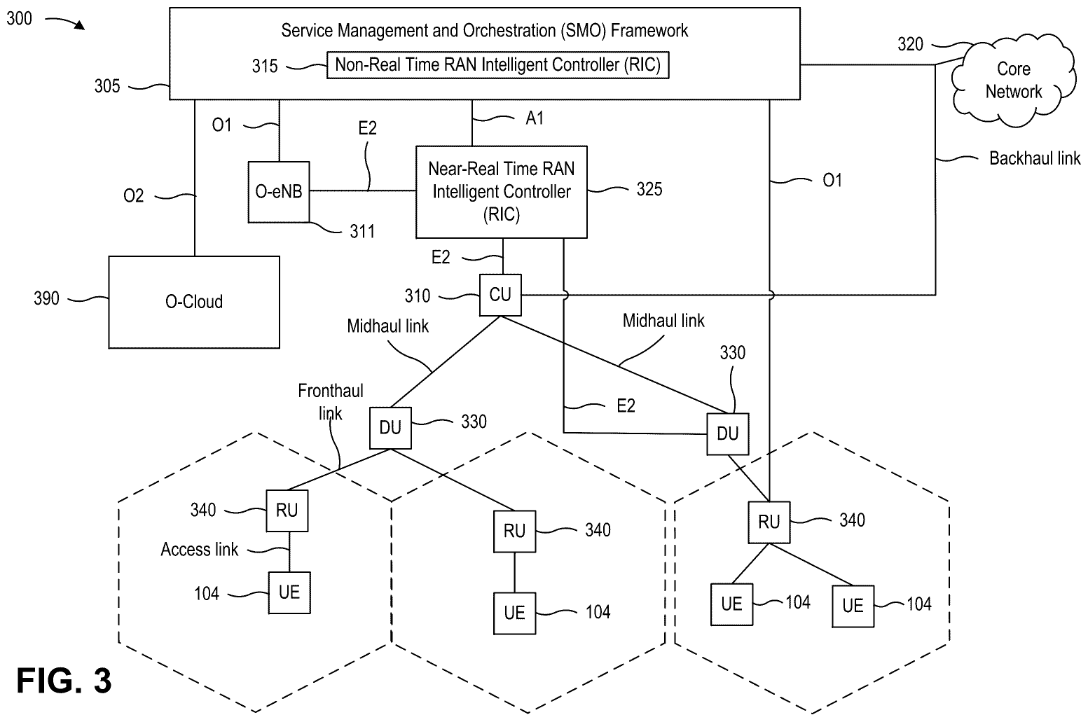

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit - User Plane (CU-UP)), control plane functionality (i.e., Central Unit - Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

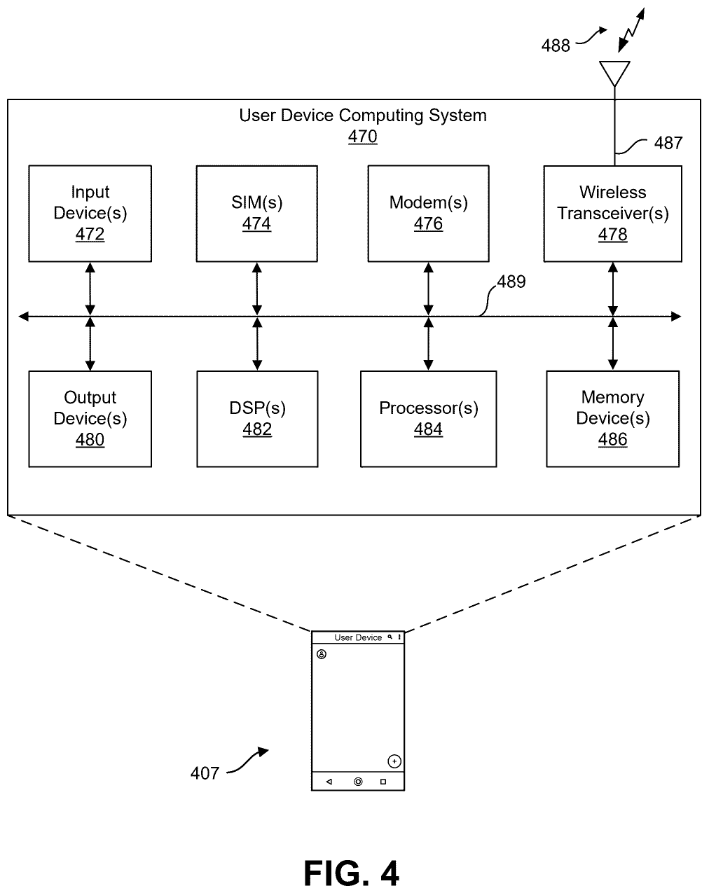

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

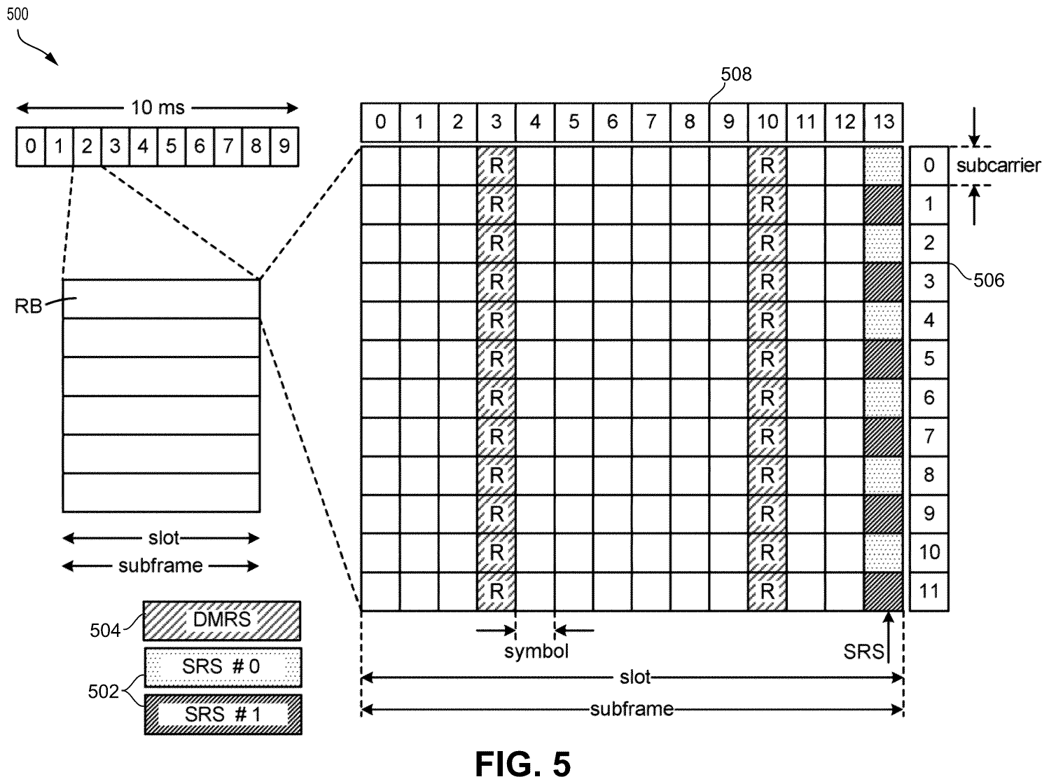

FIG. 5 is a resource grid 500 illustrating an example of an uplink frame structure, according to aspects of the disclosure. Of note, while discussed in context of an unlink frame structure, the concepts discussed herein may be applied to a downlink frame with a downlink frame structure in a substantially similar manner. LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies, for example, subcarrier spacing of 15 kHz, 30 kHz, 60 kHz, 120 kHz and 240 kHz or greater may be available. In the example of FIG. 4, a numerology of 15 kHz is used. Thus, in the time domain, a frame (e.g., 10 ms) is divided into 10 equally sized subframes of 1 ms each, and each subframe includes one time slot. In FIG. 5, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 5, for a normal cyclic prefix, an RB may contain 12 consecutive subcarriers 506 in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers 506 in the frequency domain and 6 consecutive symbols in the time domain, for a total of 72 REs. The number of bits carried by each RE depends on the modulation scheme.

As illustrated in FIG. 5, the UE may transmit sounding reference signals (SRS) 502 in, for example, the last symbol of a subframe. The SRS 502 may have a comb structure, and a UE may transmit SRS 502 on one of the combs. The comb structure (also referred to as the “comb size”) indicates the number of subcarriers in each symbol period carrying a reference signal (here, SRS 502). For example, a comb size of comb-4 means that every fourth subcarrier of a given symbol carries the reference signal, whereas a comb size of comb-2 means that every second subcarrier of a given symbol carries the reference signal. In the example of FIG. 5, the illustrated SRS both have a comb size of comb-2. The SRS 502 may be used by a base station to obtain the channel state information (CSI) for each UE. CSI describes how an RF signal propagates from the UE to the base station and represents the combined effect of scattering, fading, and power decay with distance. The system uses the SRS 502 for resource scheduling, link adaptation, massive MIMO, beam management, etc.

Additionally, some of the REs carry demodulation reference signals (DMRS) 504 for channel estimation at the base station. In some cases, a specific DMRS pattern (e.g., position (REs) of the DMRS in the resource grid and repetition (if any), here the DMRS pattern is that the DMRS are transmitted in the third and tenth symbol of a subframe) and/or DMRS sequence (e.g., information in (e.g., tones of) the DMRS) for a wireless device may be configured by a wireless network. A receiver may then receive an expected DMRS sequence based on the DMRS pattern (from the REs carrying the DMRS) and estimate channel properties as between a transmitter and the receiver. These channel properties may be used to decode signals transmitted in other REs (e.g., REs not containing the DMRS).

In some cases, generation of the DMRS sequence along with a DMRS pattern in which the DMRS signals are generated may be defined based on a specification. For example, the DMRS pattern indicating the locations of the DMRS signal in a wireless signal, along with the DMRS sequence indicating the contents of the DMRS signal may be defined by a specification for the wireless network. Therefore, the potential locations (e.g., DMRS pattern) of the DMRS are well known and public. In some cases, it may be useful to hide (e.g., conceal, obfuscate, etc.) the DMRS pattern and/or scramble the DMRS sequence to provide a level of privacy and/or security as it may be very difficult, if not impossible, for a receiver to decode the signals that are received without a DMRS signal to use to determine channel properties. Additionally, it may be difficult to locate the DMRS signal in a subframe without prior knowledge of where DMRS should be and/or without prior knowledge of what the DMRS signal should be (e.g., the DMRS sequence and DMRS pattern being used). Thus, randomizing the DMRS pattern and/or DMRS sequence may provide a level of privacy and/or security for lower layer signaling.

In some cases, to allow random DMRS patterns and/or sequences to be used, a UE may have already have access stratum (AS) security setup, for example, based on an AS security mode command (SMC) procedure. In some cases, the AS may be used to establish and maintain logical channels for transmitting and receiving data and control information over the air interface between the UE and a radio access network (RAN). As a part of AS security, a UE and a wireless node, such as a BS, eNB, gNB, DU, etc., may share an access stratum key or AS key (e.g., K_{gNB}, in 5G or equivalent in 6G, such as K_{DU}, or other AS root key) and derive subsequent keys for control-plane signaling protection and user-plane data protection (e.g., K_{rrcenc}, K_{rrcint}, K_{upenc}, Kᵤₚᵢₙₜ, etc.).

In some cases, the UE and wireless node may derive, from the AS key (e.g., K_{gNB}, K_{DU} or equivalent), a DMRS key K_{PHY} (referred to herein as a physical layer key or PHY key). The DMRS key K_{PHY} (or other PHY layer key) may be used to generate a UE specific DMRS sequence. For example, the DMRS sequence may be determined as DMRS sequence=f(K_{PHY}, type, freshness parameter), where the type may be type of a PHY channel (e.g., PDCCH, PDSCH, PUCCH, PUSCH, or other channel that may use a DMRS), and where the freshness parameter is a value that may be used to avoid replay attacks as the freshness parameter may be changed for each derivation of the DMRS sequence even if the DMRS key K_{PHY} is not refreshed. Examples of the freshness parameter may include a system frame number (SFN), hyper frame number (HFN), subframe number, slot number, frequency being used, etc. In some cases, K_{PHY} may be refreshed before the freshness parameter may be repeated (e.g., via SFN/HFN wrap-around). The function f may be a one-way function such as a cryptographic hash function like SHA-2, SHA-3, etc. In some cases, f may be an encryption function such as AES-CTR (AES counter mode of encryption), SNOW 3G, ZUC, etc. In some cases, the function f may be used to derive cᵢₙᵢₜ that may be used to determine a DMRS sequence. In cases where an encryption function is used, the DMRS signal may be encrypted. In some cases, different DMRS sequences may be generated for different types of PHY channels based on the type parameter.

As indicated above, K_{PHY} may be refreshed. In some cases, K_{PHY} may be refreshed periodically after a certain amount of time. In some cases, a new K_{PHY} may be derived based on a current K_{PHY}. For example, a new K_{PHY} may be derived as K_{PHY}=KDF(K_{PHY}, Cell ID, count), where KDF may be a key derivation function, such as a cryptographic has function like SHA-2, HMAC-SHA2, etc. The cell ID may be a cell ID associated with the wireless node. The count may be a value that may be indicated to the UE. The count may be explicitly or implicitly indicated. For example, the count may be explicitly signaled or the count may be determined implicitly based on a single bit of a count change indication (e.g., message sent to the UE to indicate that the count may be changed).

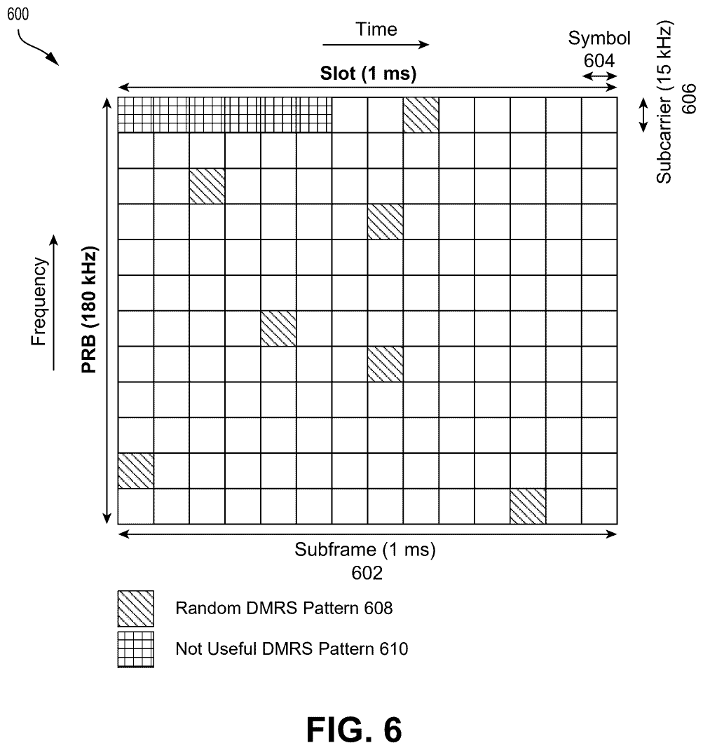

In some cases, the position of the DMRS (e.g., DMRS pattern) may also be varied. FIG. 6 is a resource grid 600 illustrating a secure DMRS pattern, in accordance with aspects of the present disclosure. The resource grid 600 illustrates one subframe 602 including 14 symbols 604 and 12 subcarriers 606. In some cases, a DMRS pattern (e.g., random DMRS pattern 608 locations in resource grid 600) may be determined based on the DMRS key K_{PHY}, one or more DMRS pattern parameters, and a DMRS pattern generation function, such that DMRS pattern=f(K_{PHY}, type, freshness parameter). In this example, the DMRS pattern parameters include a type parameter indicating a PHY channel type (e.g., PDCCH, PDSCH, PUCCH, PUSCH, etc.) and a freshness parameter. The DMRS pattern generation function f may be based on one or more one-way functions such as a cryptographic has function like SHA-2, SHA-3, etc., or other function, and the freshness parameter may be similar to the freshness parameter that may be used for generating the DMRS sequence above. The type may be a DMRS pattern parameter indicating a type of PHY channel the DMRS pattern is being generated for, such PDCCH, PDSCH, PUCCH, PUSCH, etc. For example, based on the DMRS pattern generation function and type information and for a narrowband resource grid 600 with 168 total REs (e.g., for a narrow band with 14 symbols 604, 12 subcarriers 606, and assuming 12 REs may be used for the random DMRS pattern 608), the DMRS pattern generation function f may generate a location for the DMRS signals of the random DMRS pattern 608 in the resource grid 600. In some cases, the DMRS pattern generation function f may determine k REs out of n total REs for use for the DMRS for C(n, k) different theoretical DMRS patterns available. For example, for the narrowband resource grid 600, there may be C(168,12) different theoretical DMRS patterns for the subframe 602. Each RE used for the DMRS may include information according the determined DMRS sequence as discussed above. In some cases, f may consist of k one-way functions that determine k different REs out of n total REs. In some cases, k or more one-way functions may be constructed using a single one-way function with a different parameter. In some cases, the number of REs that may be used for DMRS (k) for a subframe may be configured by the wireless node.

In some cases, not every random theoretical DMRS pattern may be useful. For example, a DMRS pattern where a set of consecutive REs are used for the DMRS pattern, such as not useful DMRS pattern 610, may not be useful as such a DMRS pattern may degrade the purpose of the DMRS design pattern. The DMRS may be used to estimate a channel across the resources represented by the resource grid 600 and it may be more difficult (e.g., inaccurate) to extrapolate channel conditions for REs which are further away from a nearest DMRS.

To help avoid DMRS patterns which are less useful, restrictions as to RE selection (e.g., DMRS pattern restrictions) for use in the DMRS pattern may be helpful. For example, certain DMRS pattern restrictions for RE selection may be configured (e.g., via RRC messaging from the wireless node to the UE). These DMRS pattern restrictions may include a number of symbols that may carry the DMRS, a minimum symbol spacing (e.g., minimum number of symbols between two DMRS REs on the symbol axis (e.g., time axis)) when more than two symbols are configured, a number (e.g., min/max number) of DMRS REs in a symbol, a minimum number of REs between DMRS tones (e.g., DMRS on the subcarrier/frequency axis), separate DMRS patterns for each precoding resource group (PRG) (for example by using the PRG index or star/end RB index of the PRG may be used as input to the DMRS pattern generation function f), a maximum number of REs between DMRS tones and/or DMRS symbols, a DMRS cover radius where for every RE in the allocation there is at least one DMRS RE within d number of REs (e.g., where d may be measured by ne Euclidean distance in the OFDM resources grid 600), etc.

In some cases, more potential DMRS locations may be generated (e.g., by the DMRS pattern generation function f) than may be used and some potential DMRS locations may be skipped when there are sufficient DMRS resources. For example, six DMRS locations may be used for OFDM resources grid 600 and ten DMRS potential locations (e.g., generated DMRS locations) may be generated by the DMRS pattern generation function f. The generated potential DMRS locations that are located where the channel may be estimated by another DMRS location (e.g., based on the restrictions discussed above) the generated potential DMRS location may be skipped.

In some cases, the skipped DMRS locations may be left as empty tones with no data sent in the skipped DMRS locations. Leaving skipped DMRS locations empty may be risky as on-off keying (e.g., on-off detection) may be possible with a relatively good signal-to-noise ratio (e.g., around >30 dB), which could reveal portions of the generated potential DMRS location to estimate a subset of the DMRS sequence. In other cases, the skipped DMRS locations may be used to carry data with rate matching around the actual DMRS tones. Inserting data into the skipped DMRS locations may make detection/estimation of the actual generated potential DMRS pattern difficult.

In some cases, the DMRS pattern and DMRS sequence may be jointly generated. For example, the DMRS pattern and DMRS sequence may be generated based on the same DMRS key K_{PHY} (or other PHY layer key). As the DMRS sequence has been randomized (or encrypted) and cannot be inferred by an attacker, less flexibility may be used for the DMRS pattern. For example, where the DMRS sequence has been randomized, the DMRS pattern randomization may be configured when the DMRS length is smaller than a certain threshold.

In some cases, such as when available DMRS resources are sufficiently limited that randomness for the DMRS sequence cannot be achieved, higher order modulation may be useful to help encode more information in the signal. This higher order modulation may add an additional dimension of randomness to help provide more randomness for the DMRS sequence. As an example, rather than using quadrature phase shift keying (QPSK) modulation for the DMRS sequence, a higher order modulation (e.g., m-QAM) may be used. In some cases, use of a different modulation scheme may be configured, for example, via RRC messaging. In some cases, changing the DMRS amplitude (e.g., via the change in modulation) may increase implementation complexity as the channel estimator depends on the DMRS sequence. Additionally, on tones with a lower DMRS power, the noise may be amplified, which may impact channel estimation quality with using higher order modulation.

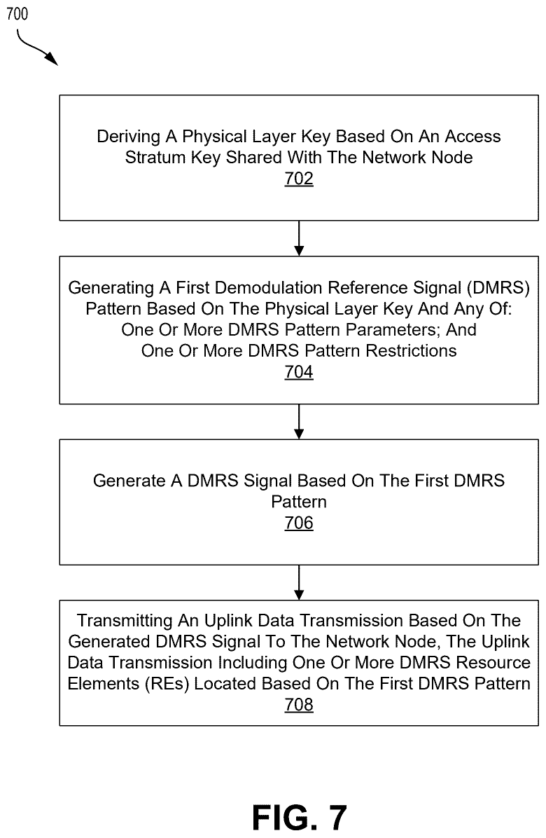

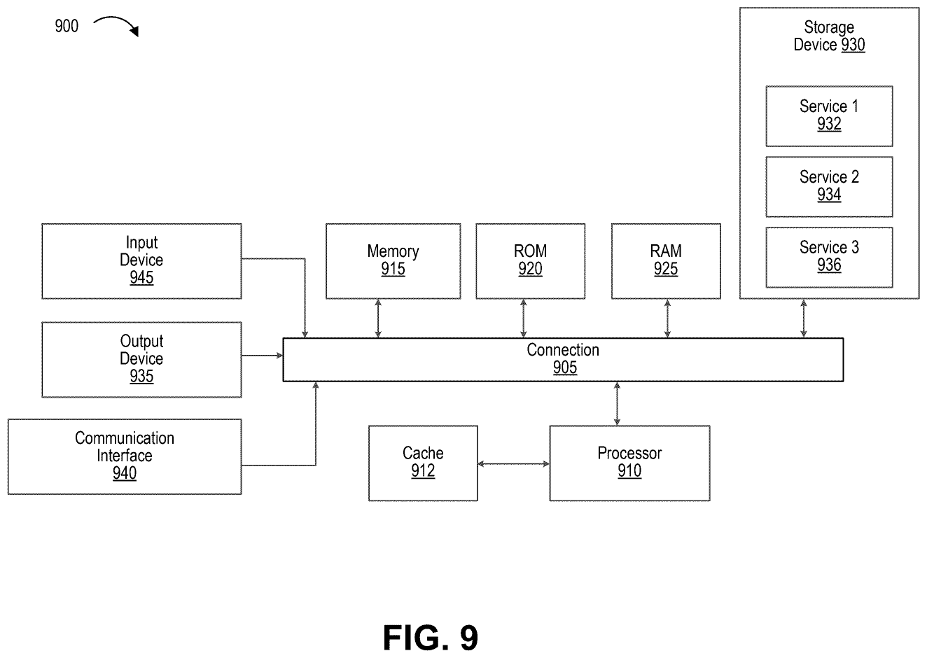

FIG. 7 is a flow diagram illustrating a process 700 for accessing a wireless network by a wireless device, in accordance with aspects of the present disclosure. The process 700 can be performed by a component or system (e.g., a chipset) of a wireless device (e.g., UE 104 of FIGS. 1 and 2, respectively, wireless device 407 of FIG. 4, computing system 900 of FIG. 9, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors (e.g., processor 484 of FIG. 4, processor 910 of FIG. 9 or other processor(s), etc.). Further, the transmission and reception of signals by the wireless device in the process 700 may be enabled, for example, by one or more antennas (e.g., antennas 252 of FIG. 2, antenna 487 of FIG. 4) and/or one or more transceivers (e.g., wireless transceiver(s) 478 of FIG. 4).

At block 702, the computing device (or component thereof) may derive a physical layer key (e.g., DMRS key K_{PHY} or other PHY layer key) based on an access stratum key (e.g., K_{gNB}, K_{DU} or equivalent) shared with the network node.

At block 704, the computing device (or component thereof) may generate a first demodulation reference signal (DMRS) pattern (e.g., random DMRS pattern 608 of FIG. 6) based on the physical layer key and at least one of one or more DMRS pattern parameters (e.g., type parameter, freshness parameter, etc.) or one or more DMRS pattern restrictions. As an example, the DMRS pattern restrictions may include a number of symbols that may carry the DMRS, a minimum symbol spacing (e.g., minimum number of symbols between two DMRS REs on the symbol axis (e.g., time axis)) when more than two symbols are configured, a number (e.g., min/max number) of DMRS REs in a symbol, a minimum number of REs between DMRS tones (e.g., DMRS on the subcarrier/frequency axis), separate DMRS patterns for each precoding resource group (PRG) (for example by using the PRG index or star/end RB index of the PRG may be used as input to the DMRS pattern generation function f), a maximum number of REs between DMRS tones and/or DMRS symbols, a DMRS cover radius where for every RE in the allocation there is at least one DMRS RE within d number of REs (e.g., where d may be measured by ne Euclidean distance in the OFDM resources grid), etc. In some cases, the computing device (or component thereof) may receive an indication of the one or more DMRS pattern restrictions from the network node. In some examples, the one or more DMRS pattern restrictions include at least one of: a number of symbols for carrying the one or more DMRS REs; a minimum symbol spacing between DMRS REs; a minimum number of DMRS REs in a symbol; a minimum spacing between DMRS tones; a maximum spacing between DMRS tones; or a maximum distance between REs and a DMRS RE. In some cases, the first DMRS pattern includes a larger number of potential DMRS locations than a number of DMRSs in the uplink data transmission. In some examples, the computing device (or component thereof) may generate the first DMRS pattern by skipping potential DMRS locations based on the one or more DMRS pattern restrictions. In some cases, to skip potential DMRS locations, the computing device (or component thereof) may: transmit an empty tone in a skipped potential DMRS location; and transmit data in the skipped potential DMRS location. In some examples, the one or more DMRS pattern parameters comprise at least one of a freshness parameter or a parameter indicating a channel type the DMRS signal is being transmitted on.

At block 706, the computing device (or component thereof) may generate a DMRS signal based on the first DMRS pattern. In some cases, the computing device (or component thereof) may generate the DMRS signal by encrypting the DMRS signal.

At block 708, the computing device (or component thereof) may transmit an uplink data transmission based on the generated DMRS signal to the network node, the uplink data transmission including one or more DMRS resource elements (REs) located based on the first DMRS pattern. In some cases, the computing device (or component thereof) may generate a second DMRS pattern; and receive a downlink data transmission based on the second DMRS pattern.

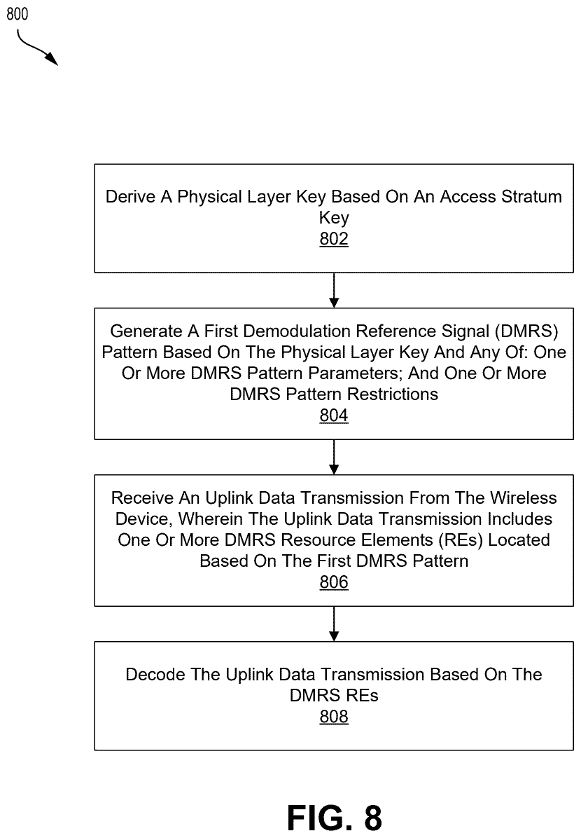

FIG. 8 is a flow diagram illustrating a process 800 for providing access to a wireless network by a wireless node, in accordance with aspects of the present disclosure. The process 800 can be performed by a component or system (e.g., a chipset) of a wireless node (e.g., BS 102, AP 150, mmW BS 180 of FIGS. 1 and 2, CU 310, DU 330, RU 340 of FIG. 3, computing system 900 of FIG. 9, etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., processor 910 of FIG. 9 or other processor(s), etc.). Further, the transmission and reception of signals by the wireless device in the process 700 may be enabled, for example, by one or more antennas (e.g., antennas 234 of FIG. 2, etc.) and/or one or more transceivers (e.g., transmit processor 220, receive processor 238 of FIG. 2, etc.).

At block 802, the computing device (or component thereof) may derive a physical layer key (e.g., DMRS key K_{PHY} or other PHY layer key) based on an access stratum key (e.g., K_{gNB}, K_{DU} or equivalent). In some cases, the computing device (or component thereof) may transmit an indication of the one or more DMRS pattern restrictions to the wireless device.

At block 804, the computing device (or component thereof) may generate a first demodulation reference signal (DMRS) pattern (e.g., random DMRS pattern 608 of FIG. 6) based on the physical layer key and any of: one or more DMRS pattern parameters (e.g., type parameter, freshness parameter, etc.); and one or more DMRS pattern restrictions. As an example, the DMRS pattern restrictions may include a number of symbols that may carry the DMRS, a minimum symbol spacing (e.g., minimum number of symbols between two DMRS REs on the symbol axis (e.g., time axis)) when more than two symbols are configured, a number (e.g., min/max number) of DMRS REs in a symbol, a minimum number of REs between DMRS tones (e.g., DMRS on the subcarrier/frequency axis), separate DMRS patterns for each precoding resource group (PRG) (for example by using the PRG index or star/end RB index of the PRG may be used as input to the DMRS pattern generation function f), a maximum number of REs between DMRS tones and/or DMRS symbols, a DMRS cover radius where for every RE in the allocation there is at least one DMRS RE within d number of REs (e.g., where d may be measured by ne Euclidean distance in the OFDM resources grid), etc. In some cases, the computing device (or component thereof) may receive an indication of the one or more DMRS pattern restrictions from the network node. In some examples, the one or more DMRS pattern restrictions include at least one of: a number of symbols for carrying the one or more DMRS REs; a minimum symbol spacing between DMRS REs; a minimum number of DMRS REs in a symbol; a minimum spacing between DMRS tones; a maximum spacing between DMRS tones; or a maximum distance between REs and a DMRS RE. In some cases, the one or more DMRS pattern restrictions include at least one of: a number of symbols for carrying the one or more DMRS REs; a minimum symbol spacing between DMRS REs of the one or more DMRS REs; a minimum number of DMRS REs in a symbol; a minimum spacing between DMRS tones; a maximum spacing between DMRS tones; or a maximum distance between REs and a DMRS RE. In some examples, the one or more DMRS pattern parameters comprise at least one of a freshness parameter or a parameter indicating a channel type the DMRS pattern is being transmitted on.

At block 806, the computing device (or component thereof) may receive an uplink data transmission from the wireless device. In some cases, the uplink data transmission includes one or more DMRS resource elements (REs) located based on the first DMRS pattern.

At block 808, the computing device (or component thereof) may decode the uplink data transmission based on the one or more DMRS REs. In some cases, the computing device (or component thereof) may generate a second DMRS pattern; generate a DMRS signal based on the second DMRS pattern; and transmit a downlink data transmission based on the DMRS signal. In some examples, the computing device (or component thereof) may generate the DMRS signal by encrypting the DMRS signal.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a wireless device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 700, 800, and/or other processes described herein may include a processor, microprocessor, micro-computer, or other component of a device that is configured to carry out the steps of the process 700, 800, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 700, 800, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The processes 700 and 800 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 700, 800, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 615, read-only memory (ROM) 620, random access memory (RAM) 625, storage device 630, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more”are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. A wireless device for communicating with a network node, comprising: a memory system comprising instructions; and a processor system coupled to the memory system, wherein the processor system is configured to: derive a physical layer key based on an access stratum key shared with the network node; generate a first demodulation reference signal (DMRS) pattern based on the physical layer key and at least one of one or more DMRS pattern parameters or one or more DMRS pattern restrictions; generate a DMRS signal based on the first DMRS pattern; and transmit an uplink data transmission based on the generated DMRS signal to the network node, the uplink data transmission including one or more DMRS resource elements (REs) located based on the first DMRS pattern.
Aspect 2. The wireless device of Aspect 1, wherein the processor system is further configured to receive an indication of the one or more DMRS pattern restrictions from the network node.
Aspect 3. The wireless device of any of Aspects 1-2, wherein the one or more DMRS pattern restrictions include at least one of: a number of symbols for carrying the one or more DMRS REs; a minimum symbol spacing between DMRS REs; a minimum number of DMRS REs in a symbol; a minimum spacing between DMRS tones; a maximum spacing between DMRS tones; or a maximum distance between REs and a DMRS RE.
Aspect 4. The wireless device of any of Aspects 1-3, wherein the first DMRS pattern includes a larger number of potential DMRS locations than a number of DMRSs in the uplink data transmission.
Aspect 5. The wireless device of Aspect 4, wherein, to generate the first DMRS pattern, the processor system is further configured to skip potential DMRS locations based on the one or more DMRS pattern restrictions.
Aspect 6. The wireless device of Aspect 5, wherein, to skip potential DMRS locations, the processor system is further configured to: transmit an empty tone in a skipped potential DMRS location; and transmit data in the skipped potential DMRS location.
Aspect 7. The wireless device of any of Aspects 1-6, wherein the one or more DMRS pattern parameters comprise at least one of a freshness parameter or a parameter indicating a channel type the DMRS signal is being transmitted on.
Aspect 8. The wireless device of any of Aspects 1-7, wherein the processor system is further configured to: generate a second DMRS pattern; and receive a downlink data transmission based on the second DMRS pattern.
Aspect 9. The wireless device of any of Aspects 1-8, wherein, to generate the DMRS signal, the processor system is further configured to encrypt the DMRS signal.
Aspect 10. A network node for communicating with a wireless device, comprising: a memory system comprising instructions; and a processor system coupled to the memory system, wherein the processor system is configured to: derive a physical layer key based on an access stratum key; generate a first demodulation reference signal (DMRS) pattern based on the physical layer key and any of: one or more DMRS pattern parameters; and one or more DMRS pattern restrictions; receive an uplink data transmission from the wireless device, wherein the uplink data transmission includes one or more DMRS resource elements (REs) located based on the first DMRS pattern; and decode the uplink data transmission based on the one or more DMRS REs.
Aspect 11. The network node of Aspect 10, wherein the processor system is further configured to transmit an indication of the one or more DMRS pattern restrictions to the wireless device.
Aspect 12. The network node of any of Aspects 10-11, wherein the one or more DMRS pattern restrictions include at least one of: a number of symbols for carrying the one or more DMRS REs; a minimum symbol spacing between DMRS REs of the one or more DMRS REs; a minimum number of DMRS REs in a symbol; a minimum spacing between DMRS tones; a maximum spacing between DMRS tones; or a maximum distance between REs and a DMRS RE.
Aspect 13. The network node of any of Aspects 10-12, wherein the one or more DMRS pattern parameters comprise at least one of a freshness parameter or a parameter indicating a channel type the DMRS pattern is being transmitted on.
Aspect 14. The network node of any of Aspects 10-13, wherein the processor system is further configured to: generate a second DMRS pattern; generate a DMRS signal based on the second DMRS pattern; and transmit a downlink data transmission based on the DMRS signal.
Aspect 15. The network node of Aspect 14, wherein, to generate the DMRS signal, the processor system is further configured to encrypt the DMRS signal.
Aspect 16. A method for communicating with a network node by a wireless device, comprising: deriving a physical layer key based on an access stratum key shared with the network node; generating a first demodulation reference signal (DMRS) pattern based on the physical layer key and at least one of one or more DMRS pattern parameters or one or more DMRS pattern restrictions; generating a DMRS signal based on the first DMRS pattern; and transmitting an uplink data transmission based on the generated DMRS signal to the network node, the uplink data transmission including one or more DMRS resource elements (REs) located based on the first DMRS pattern.
Aspect 17. The method of Aspect 16, further comprising: receiving an indication of the one or more DMRS pattern restrictions from the network node.
Aspect 18. The method of any of Aspects 16-17, wherein the one or more DMRS pattern restrictions include at least one of: a number of symbols for carrying the one or more DMRS REs; a minimum symbol spacing between DMRS REs; a minimum number of DMRS REs in a symbol; a minimum spacing between DMRS tones; a maximum spacing between DMRS tones; or a maximum distance between REs and a DMRS RE.
Aspect 19. The method of any of Aspects 16-18, wherein the first DMRS pattern includes a larger number of potential DMRS locations than a number of DMRSs in the uplink data transmission.
Aspect 20. The method of Aspect 19, wherein generating the first DMRS pattern comprises skipping potential DMRS locations based on the one or more DMRS pattern restrictions.
Aspect 21. The method of Aspect 20, wherein skipping potential DMRS locations comprises one of: transmitting an empty tone in a skipped potential DMRS location; and transmitting data in the skipped potential DMRS location.
Aspect 22. The method of any of Aspects 16-21, wherein the one or more DMRS pattern parameters comprise at least one of a freshness parameter or a parameter indicating a channel type the DMRS signal is being transmitted on.
Aspect 23. The method of any of Aspects 16-22, further comprising: generating a second DMRS pattern; and receiving a downlink data transmission based on the second DMRS pattern.
Aspect 24. The method of any of Aspects 16-23, wherein generating the DMRS signal further comprises encrypting the DMRS signal.
Aspect 25. A method for communicating with a wireless device by a network node, comprising: deriving a physical layer key based on an access stratum key; generating a first demodulation reference signal (DMRS) pattern based on the physical layer key and any of: one or more DMRS pattern parameters; and one or more DMRS pattern restrictions; receiving an uplink data transmission from the wireless device, wherein the uplink data transmission includes one or more DMRS resource elements (REs) located based on the first DMRS pattern; and decoding the uplink data transmission based on the one or more DMRS REs.
Aspect 26. The method of Aspect 25, further comprising: transmitting an indication of the one or more DMRS pattern restrictions to the wireless device.
Aspect 27. The method of any of Aspects 25-26, wherein the one or more DMRS pattern restrictions include at least one of: a number of symbols for carrying the one or more DMRS REs; a minimum symbol spacing between DMRS REs of the one or more DMRS REs; a minimum number of DMRS REs in a symbol; a minimum spacing between DMRS tones; a maximum spacing between DMRS tones; or a maximum distance between REs and a DMRS RE.
Aspect 28. The method of any of Aspects 25-27, wherein the one or more DMRS pattern parameters comprise at least one of a freshness parameter or a parameter indicating a channel type the DMRS pattern is being transmitted on.
Aspect 29. The method of any of Aspects 25-28, further comprising: generating a second DMRS pattern; generating a DMRS signal based on the second DMRS pattern; and transmitting a downlink data transmission based on the DMRS signal.
Aspect 30. The method of Aspect 29, wherein generating the DMRS signal further comprises encrypting the DMRS signal.
Aspect 31. A non-transitory computer-readable storage medium comprising instructions stored thereon which, when executed by a processor system, causes the processor system to perform operations according to any of Aspects 16-24.
Aspect 32. A non-transitory computer-readable storage medium comprising instructions stored thereon which, when executed by a processor system, causes the processor system to perform operations according to any of Aspects 25-30.
Aspect 33. An apparatus for wireless communications comprising one or more means for performing operations according to any of Aspects 16-24.
Aspect 34. An apparatus for wireless communications comprising one or more means for performing operations according to any of Aspects 25-30.

What is claimed is:

1. A wireless device for communicating with a network node, comprising:
a memory system comprising instructions; and
a processor system coupled to the memory system, wherein the processor system is configured to:
derive a physical layer key based on an access stratum key shared with the network node;
generate a first demodulation reference signal (DMRS) pattern based on the physical layer key and at least one of one or more DMRS pattern parameters or one or more DMRS pattern restrictions;
generate a DMRS signal based on the first DMRS pattern; and
transmit an uplink data transmission based on the generated DMRS signal to the network node, the uplink data transmission including one or more DMRS resource elements (REs) located based on the first DMRS pattern.

2. The wireless device of claim 1, wherein the processor system is further configured to receive an indication of the one or more DMRS pattern restrictions from the network node.

3. The wireless device of claim 1, wherein the one or more DMRS pattern restrictions include at least one of:
a number of symbols for carrying the one or more DMRS REs;
a minimum symbol spacing between DMRS REs;
a minimum number of DMRS REs in a symbol;
a minimum spacing between DMRS tones;
a maximum spacing between DMRS tones; or
a maximum distance between REs and a DMRS RE.

4. The wireless device of claim 1, wherein the first DMRS pattern includes a larger number of potential DMRS locations than a number of DMRSs in the uplink data transmission.

5. The wireless device of claim 4, wherein, to generate the first DMRS pattern, the processor system is further configured to skip potential DMRS locations based on the one or more DMRS pattern restrictions.

6. The wireless device of claim 5, wherein, to skip potential DMRS locations, the processor system is further configured to:
transmit an empty tone in a skipped potential DMRS location; and
transmit data in the skipped potential DMRS location.

7. The wireless device of claim 1, wherein the one or more DMRS pattern parameters comprise at least one of a freshness parameter or a parameter indicating a channel type the DMRS signal is being transmitted on.

8. The wireless device of claim 1, wherein the processor system is further configured to:
generate a second DMRS pattern; and
receive a downlink data transmission based on the second DMRS pattern.

9. The wireless device of claim 1, wherein, to generate the DMRS signal, the processor system is further configured to encrypt the DMRS signal.

10. A network node for communicating with a wireless device, comprising:
a memory system comprising instructions; and
a processor system coupled to the memory system, wherein the processor system is configured to:
derive a physical layer key based on an access stratum key;
generate a first demodulation reference signal (DMRS) pattern based on the physical layer key and any of:
one or more DMRS pattern parameters; and
one or more DMRS pattern restrictions;
receive an uplink data transmission from the wireless device, wherein the uplink data transmission includes one or more DMRS resource elements (REs) located based on the first DMRS pattern; and
decode the uplink data transmission based on the one or more DMRS REs.

11. The network node of claim 10, wherein the processor system is further configured to transmit an indication of the one or more DMRS pattern restrictions to the wireless device.

12. The network node of claim 10, wherein the one or more DMRS pattern restrictions include at least one of:
a number of symbols for carrying the one or more DMRS REs;
a minimum symbol spacing between DMRS REs of the one or more DMRS REs;
a minimum number of DMRS REs in a symbol;
a minimum spacing between DMRS tones;
a maximum spacing between DMRS tones; or
a maximum distance between REs and a DMRS RE.

13. The network node of claim 10, wherein the one or more DMRS pattern parameters comprise at least one of a freshness parameter or a parameter indicating a channel type the DMRS pattern is being transmitted on.

14. The network node of claim 10, wherein the processor system is further configured to:
generate a second DMRS pattern;
generate a DMRS signal based on the second DMRS pattern; and
transmit a downlink data transmission based on the DMRS signal.

15. The network node of claim 14, wherein, to generate the DMRS signal, the processor system is further configured to encrypt the DMRS signal.

16. A method for communicating with a network node by a wireless device, comprising:
deriving a physical layer key based on an access stratum key shared with the network node;
generating a first demodulation reference signal (DMRS) pattern based on the physical layer key and at least one of one or more DMRS pattern parameters or one or more DMRS pattern restrictions;
generating a DMRS signal based on the first DMRS pattern; and
transmitting an uplink data transmission based on the generated DMRS signal to the network node, the uplink data transmission including one or more DMRS resource elements (REs) located based on the first DMRS pattern.

17. The method of claim 16, further comprising: receiving an indication of the one or more DMRS pattern restrictions from the network node.

18. The method of claim 16, wherein the one or more DMRS pattern restrictions include at least one of:
a number of symbols for carrying the one or more DMRS REs;
a minimum symbol spacing between DMRS REs;
a minimum number of DMRS REs in a symbol;
a minimum spacing between DMRS tones;
a maximum spacing between DMRS tones; or
a maximum distance between REs and a DMRS RE.

19. The method of claim 16, wherein the first DMRS pattern includes a larger number of potential DMRS locations than a number of DMRSs in the uplink data transmission.

20. The method of claim 19, wherein generating the first DMRS pattern comprises skipping potential DMRS locations based on the one or more DMRS pattern restrictions.
